(19) United States
(12) Patent Application Publication
(10) Pub. No.: US 2011/0083082 A1
(43) Pub. Date: Apr. 7, 2011

(54) FRACTIONAL DOWNLOAD BASED ON CURRENTLY PRESENTED PORTIONS FROM LARGE CONTENT PAGES

(76) Inventors: Thomas Gottwald, Vienna (AT); Andreas Buchwald, Oberwalterdorf (AT)

(21) Appl. No.: 12/572,893

(22) Filed: Oct. 2, 2009

(51) Int. Cl. G06F 3/00

(52) U.S. Cl. 715/744

(57) ABSTRACT

Methods, systems, and apparatus, including computer program products, for fractional download of content pages in a data network including one or more servers and client devices. A single page layout is identified for a content page to be downloaded from a server to a client device in the data network. The single page layout defines a geometrical arrangement of content reservation areas for presenting respective content elements from the entire content page. For example, the single page layout can include hierarchically arranged containers. An active portion is identified in the single page layout, where the active portion corresponds to a display area for displaying the content page on a display unit of the client device. Content elements are provided to the client device for the content reservation areas in the active portion of the single page layout without providing content elements for content reservation areas that are outside of the active portion.

### BACKGROUND

The present invention relates to accessing, downloading and presenting content pages available through a data network or from some other sources.

Data networks, such as local area networks (LANs), wide area networks (WANs), the Internet, and other computer or telephone based data networks, can provide users with access to a large amount of information. A well known example of such data network is the World Wide Web (WWW). In these data networks, specific information content can be requested by client devices and the requested information content is provided by servers. The client devices can include computers or portable or hand-held devices that communicate with the servers in the network through wired or wireless connections. The servers typically include computers which store and manage the information content and serve multiple clients. In general, the server organizes the stored information content into multiple content pages and serves each client with one page at a time (the page, however, may also import information from other servers or any other available data source). On the World Wide Web (WWW), for example, Websites typically include an interlinked collection of web pages and the server provides one web page at a time to the client device. The client device stores the received page and uses a browser application to allow the user to review the content in the received page. Examples of such browser applications include Internet Explorer from Microsoft Corporation and Firefox from Mozilla Corporation. If the user would like to access information in another content page, the client device has to download, i.e., request and subsequently receive, that entire content page in the browser application.

In these data networks, the user experience depends on factors that include the capabilities of the server, the connection, and the client device, as well as the organization of the information content. For example, portable and handheld devices may have limited storage and processing capabilities and often use wireless connections with a small-bandwidth. With such devices, the user may experience substantial delays when trying to download a content page, in particular, if the content page includes a lot of information. To avoid that problem, some prior art servers serve smaller content pages to handheld client devices. But even with more capable client devices and connections having more bandwidth, the user-experienced delay may be substantial if a single content page includes too much information. To avoid such delays, the full information content of the server is typically organized into multiple content pages which are interlinked so that the user can navigate through those pages—one page at a time. In addition, some servers also try to improve the user experience by providing updates that, instead of serving a new version of an entire content page, serve only the changes to a previously downloaded page.

### SUMMARY

According to some aspects of the invention, a client device can selectively download information from a single content page on a server based on a current display position in the client device. Thus, in some implementations, the system can avoid downloading information that, although being part of the single content page, is actually not displayed to the user. In another aspect, a hierarchical arrangement of information containers is used to select the information to be downloaded and to determine the current display position in an efficient way even in a very large content page. Thus, processing and storing resources can be saved in the client device or the server and the user experience can be improved by avoiding unnecessary delays and navigation through multiple pages.

In general, in one aspect, the present invention provides a method and corresponding system and software products for accessing information by a client device in a data network. The client device includes a local storage unit and a display unit, and the method includes identifying a single page layout for a content page to be downloaded from a server in the data network. The single page layout defines a geometrical arrangement of content reservation areas for presenting respective content elements from the entire content page. The method also includes identifying an active portion in the single page layout, where the active portion corresponds to a display area for displaying the content page on the display unit. The client device requests content elements from the server for the content reservation areas in the active portion of the single page layout without requesting content elements for content reservation areas that are outside of the active portion in the single page layout. The requested content elements are displayed in the display area on the display unit according to the single page layout.

In general, in another aspect, the present invention provides a method and corresponding system and software products for providing information by a server in a data network. The server includes a controller and a storage unit. The method includes receiving information about display parameters of a client device in the data network, and determining a single page layout based on the display parameters for a content page to be downloaded to the client device. The single page layout defines a geometrical arrangement of content reservation areas for presenting respective content elements from the entire content page. The server sends information about the single page layout to the client device and receives a request from the client device for content elements in an active portion of the single page layout. The server sends to the client device the content elements for the content reservation areas in the active portion of the single page layout without sending content elements for content reservation areas that are outside of the active portion in the single page layout.

Particular implementations can include one or more of the following features. The single page layout can include multiple containers, each container corresponding to a respective area in the single page layout. One or more of the containers can reserve a respective area for other containers. One or more of the containers can correspond to a respective content reservation area. The containers can be hierarchically arranged in two or more layers including first and second layers, wherein the first layer has at least one container that includes one or more containers of the second layer. The number of layers or the number of containers in another container can be changed in response to a performance parameter. A container of the first layer can include between one and 150 containers of the second layer. The active portion can be identified based on the hierarchical arrangement of the containers. For example, the active portion can be identified by identifying a first level container that includes the active portion and subsequently identifying within the first level container a second level container that includes the active portion. The single page layout can include more than ten thousand containers. Identifying the single page layout can include sending information to the server about the display area for displaying the content page, and receiving the single page layout for the content page from the server. The content elements can include previews. For example, each preview can include a visual presentation and a link to a content object corresponding to that preview. The linked content object can include an image, a document, video data, audio data, or a data set from a database. The client device can receive user input requesting change in the active portion, and a new active portion can be identified in the single page layout according to the user input. The client device can request content elements from the server for the new active portion without requesting content elements that are outside of the new active portion in the single page layout. The requested content elements can be displayed in the display area on the display unit according to the single page layout. The user input can request scrolling up or down in the content page or request displaying a specific portion in the content page. For example, the user input can request a jump to the specific portion by using links from a user interface map showing a structure of the content page. The user input can also request a change in the single page layout and a new single page layout can be identified for the content page according to the user input. A new active portion can be identified in the new single page layout, and the client device can request content elements from the server for the new active portion without requesting content elements that are outside of the new active portion in the new single page layout. The requested content elements can be displayed in the display area on the display unit according to the new single page layout. For example, the user input can request changing the display area, filtering the content elements in the content page, or using a larger or smaller representation of the content elements in the content page. The server can receive a request from she client device for info ration in the content page and send page initialization information to the client device in response to the request. The page initialization info nation can include information for a fractional page loader in the client device. The fractional page loader can be configured to identify an active portion in the single page layout and to request the content elements for the active portion from the server. The fractional page loader can be in a JavaScript format. The data network can include the World Wide Web and the server can provide information from a website.

Particular embodiments can be implemented to realize one or more of the following advantages. A large amount of information may be organized in a single page layout and presented to a user without downloading the entire page. Thus, the single page layout can include more than thousand objects, such as more than ten thousand or hundred thousand objects, or even more, such as one million objects. Also, client devices or servers with limited processing or storing capabilities or slow connections may still be able to provide access to content pages having a large amount of information. For example, the unnecessary delay or memory requirements associated with downloading the entire page may be avoided. Thus, the user may have the experience that all the information in the single large page is readily available for his or her review. Organizing a large amount of information in a single page layout may also help the user's navigation experience. Such single-page organization may be particularly advantageous for presenting previews for many objects. For example, the user may find a particular object faster in a Website by first taking a quick look at some or potentially all available objects as arranged on a single page. Based on that review, the user may be able to make an informed selection or apply a filter that would remove some of the objects the user is not interested in. Such objects for review may include, pictures, videos, documents, news items, advertisements, real estates, personals or any other listings, for example. By using a single page layout, the user may also avoid complicated navigation through multiple interlinked pages. For example, the time consuming forward and backward clicking through multiple pages may not be necessary. Within the simple single-page layout, the user is less likely of being “lost” as opposed to the “maze” of interlinked pages. Also, the user may use a simple and intuitive scroll bar to navigate. Or the user may navigate by using links arranged in a clear map showing the structure of the information content. The single-page layout may also provide the user with a sense of the amount of available information. The techniques of the present invention may also be implemented in client devices that use prior art browser applications, such as prior art Web browsers. In some embodiments, the prior art web browsers may be used without installing complicated software updates or plug-ins.

### BRIEF DESCRIPTION OF THE DRAWINGS

FIG. 1 is a schematic block diagram illustrating a data network implemented according to one aspect of the invention.

FIGS. 2 and 3 are schematic flow charts illustrating methods for downloading information from a content page according to different aspects of the invention,

FIGS. 4 and 5 are schematic diagrams illustrating exemplary embodiments of single page layouts according to different aspects of the invention.

FIG. 6 illustrates an exemplary screen shot from a client device implemented according to one aspect of the invention.

### DETAILED DESCRIPTION

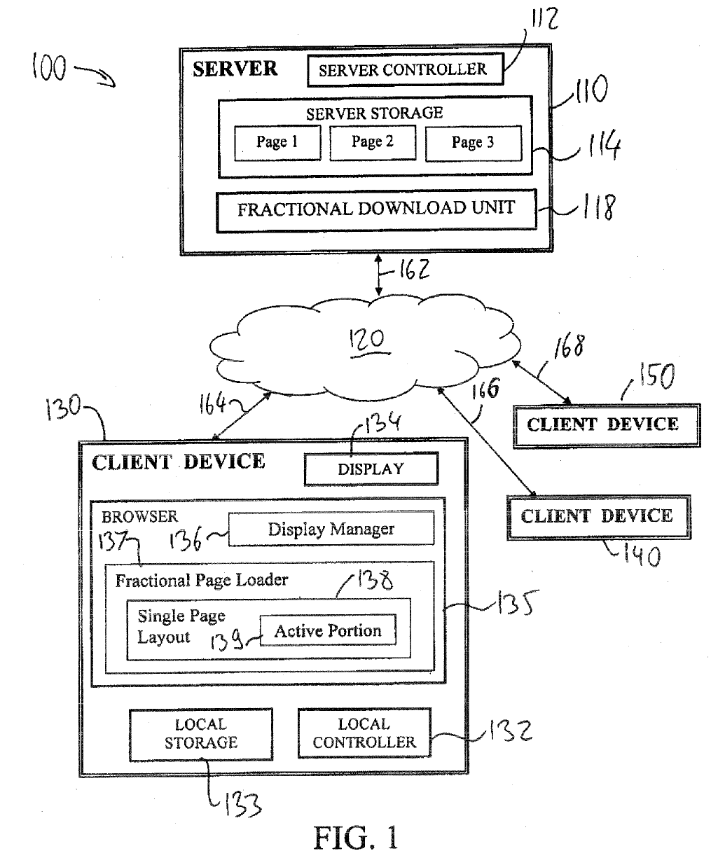

FIG. 1 schematically illustrates a data network 100 implemented according to one aspect of the invention. In this exemplary embodiment, the data network 100 includes a server 110 that provides information content through a communication network 120 to client devices 130, 140 and 150. In particular, the server 110 can provide presentation based fractional (and, optionally, traditional) downloading services to the client devices 130, 140, and 150.

The data network 100 also uses wired or wireless connections 162, 164, 166, and 168 as part of the communication paths between the server 110 and client deices 130, 140 and 150, respectively. In alternative embodiments, the data network 100 can include a different number of servers or clients as well as direct connections between the server 110 and any of the clients 130, 140 and 150. Furthermore, the communication network 120 can include a local area network (LAN), a wide area network (WAN), or the Internet. The communication network 120 and the connections 162-168 can also include different types of communications, such as communication services through cable, satellite or telephone networks.

The server 110 provides fractional (and optionally traditional) downloading services and includes a server controller 112, a server storage unit 114 and a fractional download unit 118. The server controller 112 controls the storage and processing of information content stored in the server storage unit 114. The server controller 112 can also control the operation of the fractional download unit 118. The storage unit 114 stores information content organized into content pages, such as Pages 1, 2 and 3. In one implementation. Pages 1, 2 and 3 can be Web pages that belong to one or more Websites. The Web pages can also be built up dynamically with content from different sources, such as from files in a separate file system (not shown) or from data sets in a separate database (not shown). Thus, Pages 1, 2, and 3 may not be completely stored on the server 110. Page 1, for example, can be a client-request-dependent content arrangement whose actual content is never stored on the server as a complete HTML-page, but built up by the server controller 112 from different sources according to the client's request.

The fractional download unit 118 receives requests for content information from client devices 130, 140 and 150. The requests for content can specify particular portions of content Pages 1, 2 and 3 and the fractional download unit 118 can serve those content portions to the respective client devices according to the requests. The requests for particular portions can include requests for particular content elements in a page. Or the requests can specify a portion of a particular page in terms of a region in a specific layout of that page.

In one implementation, the fractional download unit 118 can also download page initialization and page layout information to any of the client devices 130, 140 and 150. For example, the fractional download unit 118 can send the requesting client device 130, 140 or 150 page initialization information that includes scripts, such as scripts in a JavaScript format. The scripts can be executed in the client device, for example, to collect information about the device's display properties and to send that display information back to the server 110. Based on the display information, the server 110 can determine page layout information for a requested content page and the fractional download unit 118 can send that page layout information back to the particular client device. Alternatively, the fractional download unit 118 can send a predetermined page layout. Subsequently, the downloaded page layout information can be used, e.g., by the client device 130 to identify and request specific content portions from the fractional download unit 118.

The client device 130 includes a local controller 132, a local storage unit 133, a display unit 134, and a browser 135. The local controller 132 controls the operation of the client device 130. The browser 135 can request and receive, i.e., download, information content from the server 110 and display the downloaded information to a user on the display unit 134. The browser 135 can also store the downloaded information in the local storage unit 133. The client device 130 can be implemented in a computer, such as a desktop or laptop computer. The client device 130 can also be implemented in a handheld device, such as a PALM, smart phone, cell phone or any other portable device that can access the data network 100.

The browser 135 includes a display manager 136 and a fractional page loader 137. The fractional page loader 137 can download, i.e., request and receive, information content from the server 110. Subsequently, the display manager 136 can display the received information on the display unit 134. The fractional page loader 137 can also determine, in cooperation with the display manager 136, a display area that is reserved for displaying the received information. For example, the display area can correspond to the display unit's entire screen or a dedicated portion of it, such as a display window or a specific part of an application window. The fractional page loader 137 can specifically request those portions of a content page from the server 110 that will be displayed in the display area on the display unit 134.

For downloading content from Page 1 of the server 110, for example, the fractional page loader 137 identifies a single page layout 138 for Page 1 and an active portion 139 within the single page layout 138. The single a page layout 138 identifies content elements of Page 1 and specifies a respective location for each of the identified content elements. Thus, the single page layout 138 provides a geometrical arrangement for the entirety of Page 1, and the active potion 139 identifies that portion of the geometrical arrangement in which content should be available for display.

In one implementation, the single page layout 138 of Page 1, as often happens, is larger than the display area (e.g. a window) reserved for the presentation of Page 1 on the display unit 134. In this case, the active portion 139 corresponds to a “visible” part of the single page layout 138 which should be displayed currently on the display unit 134. Based on the active portion 139 of the single page layout 138, the fractional page loader 137 can identify and download those content elements of Page 1 which are needed for the current display. Thus, the fractional page loader 137 may avoid the unnecessary downloading of those portions of Page 1 which would not be currently displayed anyway.

If the user instructs the browser 135 to show a different part of Page 1, e.g., the user scrolls up or down or jumps to another portion of Page 1, the fractional page loader 137 updates the active portion 139 to correspond to the new “visible” part of the single page layout 138 and downloads the content elements missing in the updated active portion 139. Thus, only a relatively small amount of data is downloaded each time the user scrolls or jumps up or down in Page 1. In some implementations, such data amount may be downloaded and displayed in a small amount of time so that the user may have the impression that the entire Page 1 is readily available for his or her review. As the data amount to be downloaded for implementing the scroll or jump depends more on the display size than on the size of the entire content page, the user experience of fast and smooth access may be maintained even if Page 1 includes a large number of content elements, such as several thousand or even hundred thousand or a million pictures, document previews, or any other objects.

In one implementation, the single page layout 138 is organized into hierarchically arranged containers each of which corresponding to a respective piece of content with a well defined size and position within the single page layout 138. In the hierarchy, a large container can include many smaller containers that, in turn, can include even smaller containers, etc. Thus, the active portion 139 can also be determined in a hierarchical way. For example, the fractional page loader 137 can first determine a which of the largest containers includes the active portion 139, and next determine that, within the active largest container, which of the smaller containers fall within the active portion 139. Thus, the active portion 139 can be efficiently and quickly identified even if the single page layout 138 includes several thousands hundred thousands or even millions of containers.

If the user instructs the browser 135 to change the single pace layout 138 for Page 1, e.g., the user requests larger or smaller representations of the content elements or changes the display area's size or shape, the fractional page loader 137 updates the single page layout 138 and the active portion 139, and downloads the content elements missing from the updated active portion 139. Again, relatively small amount of data may be downloaded to implement the user's request, thus the user may have the impression that each portion of Page 1 is readily available.

In one implementation, the local controller 132 and the browser 135 are configured to manage the local storage unit 133 in accordance with the user's scrolling and jumping through the accessed Page 1. For example, each time a new content element is downloaded, it can be stored in the local storage unit 133 until all content elements in Page 1 are collected. Alternatively, the local controller 132 can delete from the local storage unit 133 content elements that are not currently displayed, for example, if the storage space used by the browser 135 exceeds a predetermined limit. Thus, the client device 130 may access and seamlessly display content even from pages in which the total amount of data exceeds the limits of the local storage unit 133.

The fractional page loader 137 can be an integral part of or a plug-in to a software application implementing the browser 135. The fractional page loader can be also implemented using standard Internet browser applications, such as Internet Explorer from Microsoft Corporation and Firefox from Mozilla Corporation. For example, the fractional page loader 137 may include a script downloaded from the server 110 as a part of an initialization operation when the client device 130 accesses the server 110. These scripts can be implemented, for example, in JavaScript format and executed using the standard Internet browser applications.

The client devices 140 and 150 can be implemented using structures similar to those discussed above with respect to client device 130. Alternatively, the client device 140 or 150 can be implemented using traditional techniques. For example, client device 140 or 150 may include a traditional browser that does not allow scripts to be executed. In this latter case, the server 110 can serve the Pages 1, 2, or 3 in their entirety to the client device 140 or 150. Alternatively, the server 110 may split up any of the Pages 1, 2, and 3, into multiple pages, for example, if the size of the original page is too large to be downloaded in its entirety in the traditional way. Thus, instead of scrolling up and down in the large original page as the present invention could allow, the user of the traditional client device 140 or 150 would access the split pages with forward and backward clicking. Accordingly, the server 110 may be implemented to provide fractional as well as traditional downloading services.

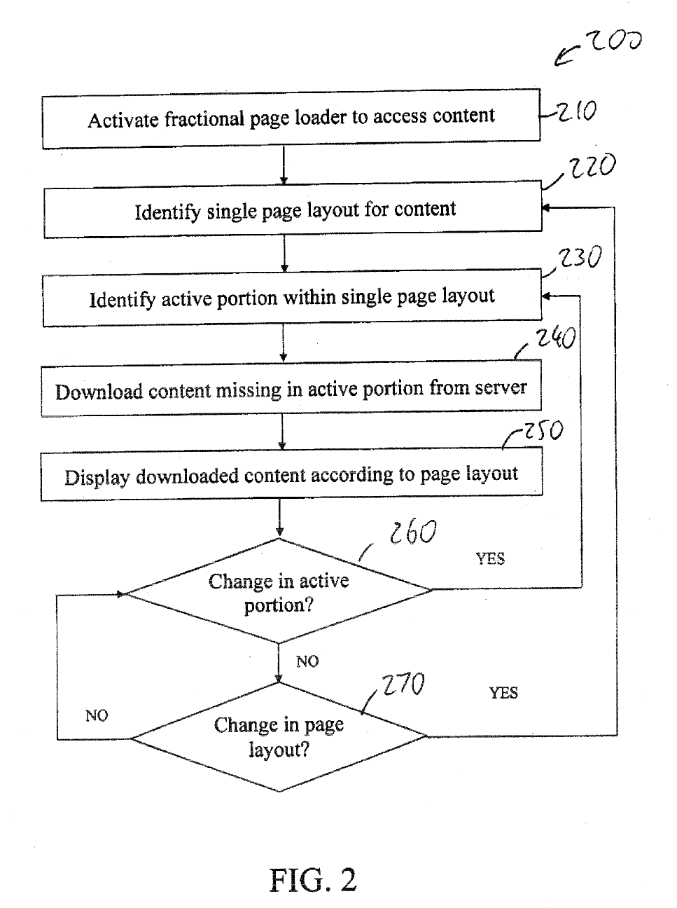

FIG. 2 illustrates a method 200 for fractional downloading according to one aspect of the invention. The method 200 can be performed by a client device, such as the client device 130 (FIG. 1), that includes a fractional page loader configured to download content information from a server in a data network. In particular, the fractional page loader is configured to identify and download those elements of a content page which are needed for the current display in the client device.

The method 200 includes activating the fractional page loader in the client device to download content from a content page in the server (step 210). In one implementation, the client device sends a request for the content page to the server, and in response, receives initialization information from the server. For example, the initialization information can include scripts that are automatically executed in the client device to implement at least portions of the fractional page loader. Alternatively, the fractional page loader can be an integral part of or a plug-in to a browser application in the client device, and activating the fractional page loader can include activating the browser application or the plug-in.

The client device identifies a single page layout for the content page (step 220). The single page layout identifies content elements and provides a defined geometrical arrangement for their presentation on a single page. For example, the single page layout can define a presentation page with specific width and height and associate a specific location and size for each content element on that presentation page. For example, the single page layout can be arranged in a hierarchy of containers, where each container has a specific location and size within the presentation page. (See, e.g., FIG. 5, illustrating a hierarchical arrangement of layers as discussed below in more detail.) The single page layout, however, may lack most of the actual content elements in the page. For example, the containers may be “empty” if they lack their content for presentation (but they may include other “empty” containers). The single page layout can be calculated by the client device based on layout information received from the server. Or the single page layout can be received directly from the server, or determined by a cooperation of the server and the client.

In one implementation, the activated fractional page loader determines measures of a window or a screen area which is dedicated to display the content page, and sends these measures to the server. For example, the window or screen can be measured in pixels or some other units. The fractional page loader can also send the server other display parameters, such as resolution and performance parameters.

The resolution and performance parameters can be used for “fine tuning” the fractional download. The performance parameters, for example, can be used to determine the size and resolution of the hierarchy of containers included in the single page layout. As an example, a hierarchy can include larger containers each of which in turn includes, say, 100 smaller containers. But the number of containers-within-a-container may vary from client to client based on the performance of those clients as characterized by their graphics capabilities or the available bandwidth. For example, fast client devices may be able to handle the smooth presentation of 150 smaller containers in one larger container, while slower clients would struggle already with 50 smaller containers. Thus, the container capacity (i.e., how many smaller containers will fit into a larger one) can be optimized based on the speed of the client devices. For clients with slow connections, the performance loss due to the more processing required for the larger number of smaller containers may be compensated by the faster loading of the corresponding smaller content portions. Accordingly, even slow client devices may be able to show a smooth presentation coupled with an overall excellent performance. Clients with faster connections, on the other hand, may take advantage of the fewer processing steps and less server-client-communications required for larger containers. The performance parameter and the corresponding hierarchy can be fixed during a given session, or they may be allowed to change dynamically within the session. For example, as the speed of the connection changes, the client and/or the server can recalculate or dynamically modify the container hierarchy. In some embodiments, these calculations and the corresponding changes in the hierarchy can be performed without any visible changes to the user.

In addition, the fractional page loader can send filtering and sorting parameters that indicate a desired selection from the available content elements and their desired presentation order, respectively. In response, the client device receives layout information from the server. The layout information can include, for example information identifying the content elements and their respective locations within the single page layout. The layout information can also include information about a grid and other arrangement of the elements. Based on the layout information, the fractional page loader can calculate the specific single page layout for the content page. In alternative implementations, the different tasks for identifying the single page layout for the content page can be assigned between the server and the client according to different arrangements.

The client device identifies an active portion within the single page layout (step 230). The active portion includes a “visible” region which should be currently displayed in the single page layout. In one implementation, the client device identifies the active portion as the current visible region of the single page layout. In alternative implementations, the active portion can also include “buffer” regions around the visible region. The visible region can be identified, for example, based on the size and shape of the window or screen area which is dedicated to display the content page and based on the corresponding location of one or more scroll bars provided in a user interface.

According to one aspect of the invention, the active portion is identified within the single page layout based on a hierarchical arrangement of information containers. In the hierarchy, containers are merged into larger containers according to some predetermined arrangement. For example, if the number of containers on one level exceeds a certain number (which may depend on performance parameters), larger containers are defined at a higher level, where each of the larger containers includes one or more of the tower level containers.

In one implementation, the system determines which container is in the visible range of the single page layout. The location of the visible range can be defined with respect to one or more reference points such as the upper edges of the hierarchically arranged containers, including the entire page as the largest container of the hierarchy. For example, the system can use standard JavaScript commands to determine an absolute scroll position, such as the distance between the upper edge of the entire page and the upper edge of the visible range. Next, the system can identify which container is currently visible by comparing the absolute scroll position with an accumulated total height of the containers, say, from top to bottom.

The accumulation of the container heights can be efficiently performed using the hierarchical arrangement. For example, the accumulation can start with the large containers to determine which of these large containers includes the visible range. Within the “visible” large container, the smaller containers' height can be accumulated until the smaller container including the visible range is found, etc. This hierarchy has a substantial advantage over a simple accumulation of the lowest-level containers' height if the page includes a large amounts of content elements: with the hierarchy, the active region can be determined quicker and with less calculation.

As an example, a page can include one million content elements, each of which corresponding to a “small” container. This page can be represented by a hierarchy with three layers: hundred “small” containers are grouped in a “large” container (giving a total of ten thousand “large” containers); and hundred “large” containers are grouped in a “larger” container (giving a total of hundred “larger” containers). The “larger” containers can be considered as being in the “largest” container, which is the entire page. When the user scrolls down close to the bottom, for example, then first the heights of the “larger” containers are accumulated from the top as long as the absolute scroll position is exceeded. As we are near the bottom of the page, this may happen after hundred accumulation steps. Next, the accumulation will proceed within the hundredth “larger” container, this time with the “large” containers until the absolute scroll position is exceeded. As we are near the bottom of the page, this may happen after about another hundred accumulation steps. If a narrower active region should be identified, that can be achieved with less than hundred additional accumulations of the “small” containers. Thus, a few hundred accumulation steps are enough even when starting from the top and identifying an active region near the bottom of the pace. Without the hierarchy, the same would require more than ten thousand, possibly in the order of hundred thousands) accumulation steps.

Furthermore, the efficiency of the hierarchical accumulation can allow the system to handle large number of containers even if their geometrical sizes or aspect ratios (width over height) varies from container to container. For example, the page's content is often grouped by a predetermined structure, such as folders or some other categories. In such cases, it is natural to select (at least some of) the containers to match those predetermined content groups. This can provide an easy identification of the content groups and the corresponding containers. Because the different groups, such folders and categories, can include a different number of items, the corresponding containers will also have different geometrical sizes. These varying sized containers can be easily handled without much computational effort by the hierarchical accumulation, even if they are numerous.

The client device downloads from the server content elements that are missing in the active portion of the single page layout (step 240). For example, the fractional page loader can identify which content elements fall at least partially into the active portion and verify whether content is available for those elements in the client device. If content is missing for one or more elements, the fractional page loader can request the missing content from the server. Thus, the client device may download content elements that should be currently displayed without downloading the entire content page.

The client device displays the downloaded content according to the single page layout (step 250). For example, each downloaded content element can be displayed in a corresponding area on the presentation page as defined in the single page layout. Thus, the newly downloaded content elements can be displayed without rearranging previously downloaded and displayed elements. Accordingly, in some implementations, “flickering” of the display may be avoided during the download of the new content elements, and the user may experience a seamless access to the content page.

The client device verifies whether there is a change in the active portion of the single page layout (decision 260). For example, the client device can verify whether the user has requested a chance in the display of the content page, such as scrolling or jumping to another portion in the single page layout. If there is a change (“YES” branch of decision 260), the client device identifies a new active portion within the single page layout according to the user's request (i.e. returns to step 230), downloads content missing in the new active portion (step 240), and displays the downloaded content according to the single page layout (step 250).

If there is no change (“NO” branch of decision 260), the method continues to verify whether there is a change in the single page layout (decision 270). For example, the client device can verify whether the user has requested a change in the size of the window used to display the content page; or the user requested filtering the displayed content; or the user requested a change in the size of the displayed objects; or the display parameters has changed for any other reason. If there is a change (“YES” branch of decision 270), the client device identifies a new single page layout and a new active portion according to the user's request (i.e. returns to steps 220 and 230), downloads content missing in the new active portion (step 240), and displays the downloaded content according to the single page layout (step 250). If there is no change in the page layout (“NO” branch of decision 270), the client device verifies whether there are changes in the active portion (i.e., returns to decision 260).

As discussed above with reference to step 230, the active portion of the single page layout can include the “visible” (i.e., currently displayed) region, as well as buffer regions. Such buffer regions can hold content information to be displayed immediately next to the visible region and may improve the user experience during scrolling, because the client device does not have to wait for completing any download to start the scrolling. Also, the size of such buffer regions may be selected to optimize user experience. For example, such optimum may take into account the effects of, in one hand, scrolling when content is downloaded only for the scrolled portion and, in the other hand, jumping to another portion of the page when content for the entire active portion is downloaded.

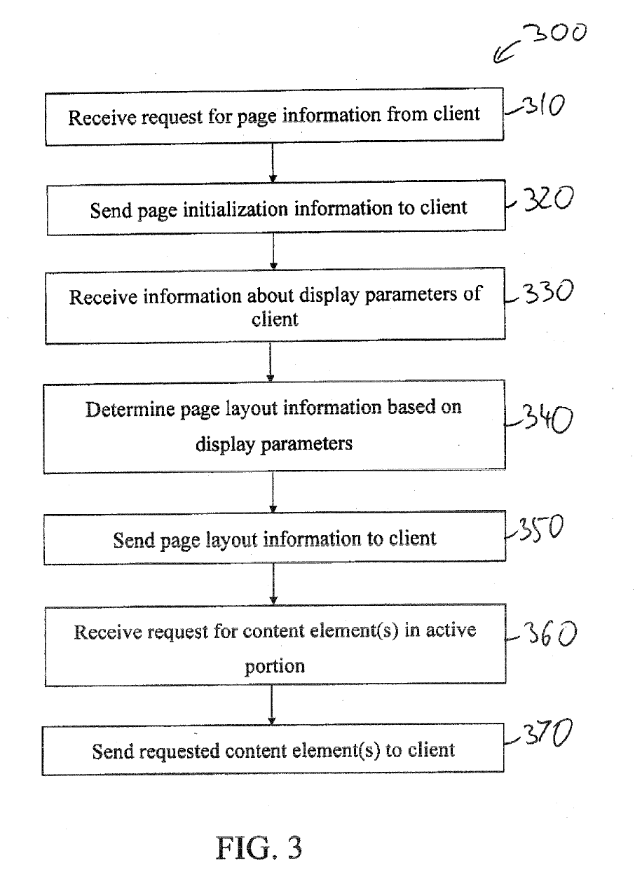

FIG. 3 illustrates a method 300 for fractional downloading according to one aspect of the invention. The method 300 can be performed by a server, such as the server 110 (FIG. 1), having a fractional download unit that is configured to provide fractional download services in a data network. In particular, the fractional download unit is configured to download those elements of a content page which are needed for the current display in a client device of the data network.

The method 300 includes receiving a request for page information from a client device in the data network (step 310) and sending page initialization information to the client device in response to the request (step 320). For example, the server can send a DHTML page for initialization in the client device. The initialization information can also include scripts, such as a fractional page loader in JavaScript format or in any other suitable programming language. Alternatively, the client device can include an integrated or plugged-in fractional page loader preinstalled on the client device (e.g., in a browser or Graphical User Interface) and the initialization information can provide information for the particular page loader in the client device.

The server receives information about display parameters of the client device (step 330). For example, the received information can include measures of a window or a screen area which is dedicated to display the content page in the client device. The display parameters can also include resolution and performance parameters of the client device. In addition, the server can receive filtering and sorting parameters that indicate a desired selection from the content elements available in the page and their desired presentation order, respectively.

The server determines page layout information based on the display parameters (step 340) and sends the page layout information to the client device (step 350). The layout information can include, for example, information identifying the content elements and their respective locations within a single page layout. The layout information can also include information about a grid or any other arrangement of the content elements. In one implementation, the layout information can define a hierarchy of containers for content elements to be displayed. In alternative implementations, the layout information can include as much and as many different types of information as follows from the particular work load arrangement between the server and the client device for identifying the single page layout for the content page. For example, the server can send page layout information that includes a detailed single page layout to be used for the content page.

The server receives a request from the client device for one or more content elements in an active portion of the single page layout (step 360) and sends the requested content elements to the client device (step 370). For example, as the user of the client device scrolls or jumps up or down in the page, the server can receive a request for those content elements that should be displayed in the new active portion of the page layout. As these requests concern only a fraction of the entire page, the server may complete sending the required content elements without substantial delay even if the entire page includes a large amount of content information, such as a large number of content elements.

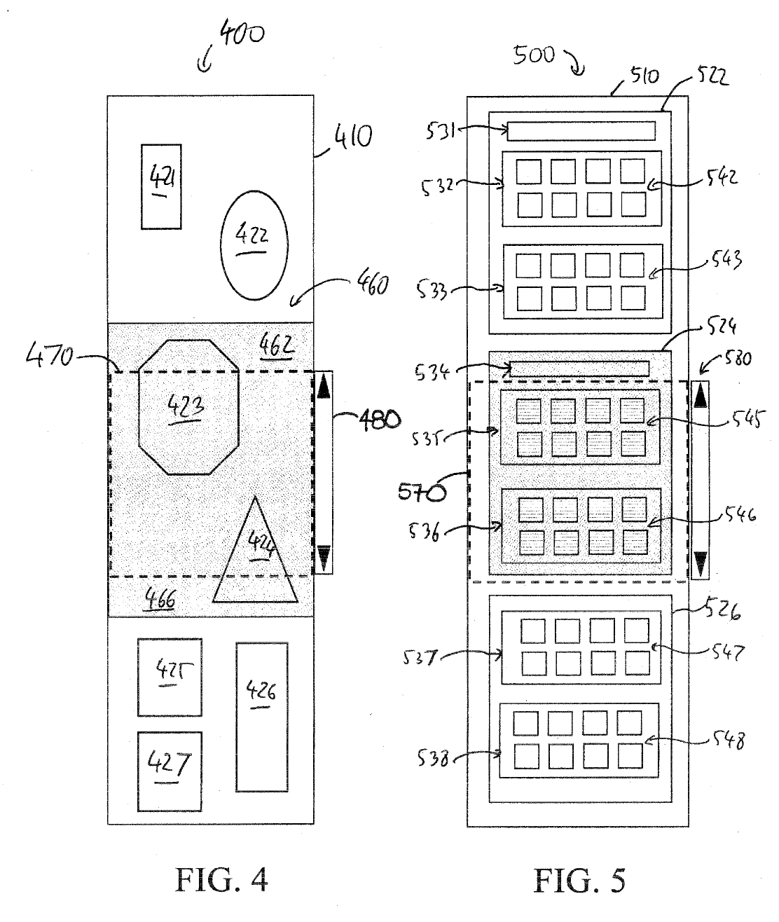

FIG. 4 illustrates an exemplary embodiment of a single page layout 400 for a content page that can be downloaded in a data network. The single page layout 400 can be implemented for fractional download by a fractional page loader, such as fractional page loader 137 in the client device 110 (FIG. 1).

The single page layout 400 includes a presentation page 410, content reservation areas 421-427, and an active portion 460. The presentation page 410 specifies an area for presenting the entire content page and respective locations for each of the content reservation areas 421-427, and the active portion 460 identifies that part of the presentation page for which the actual content elements should be downloaded into the client device. In the example, the content elements should be downloaded for the content reservation areas 423 and 424. However, the actual content is not required for the content reservation areas 421, 422, and 425-427, which are outside of the active portion 460 of the presentation page 410.

The presentation page 410 has a defined geometrical shape and it also specifies the geometrical arrangement, including location, area and shape, for each of the content reservation areas 421-427. The content reservation areas 421-427 can have different shapes and sizes and can be arranged in a regular or a non-regular way. In the example shown, the content reservation areas 421 and 425-427 have rectangular shapes, content reservation area 422 has an elliptic shape, content reservation area 423 has an octagonal shape and content reservation area 424 has a triangular shape. In alternative implementations, the content reservation areas can have different numbers, shapes or areas.

The active portion 460 includes a “visible” region 470 of the presentation page 410. The visible region 470 represents the region of the presentation page 410 which falls within a display area designated to display the content page in the client device. In this example, as often happens if the content page includes a large number of content elements, the presentation page 410 exceeds the visible region 470. As the visible region 470 does not include the entire presentation page 410, the user is provided with a scroll bar 480 to select the visible region 470. In addition to or instead of the scroll bar 480, the client device can provide other tools for navigation within the single page layout 400. For example, the user may be able to navigate using links pointing to different portions of the single page layout 400.

In addition to the visible region 470, the active portion 460 also includes buffer regions 462 and 466. In some implementations, the buffer regions 462 and 466 may be selected to optimize the user's scrolling experience as discussed above in more detail with reference to FIG. 2.

Furthermore, the exemplary presentation page 410 has a width that matches that of the visible region 470. In alternative implementations, however, the presentation page 410 can be wider or narrower than the visible region 470. For example, if the presentation page 410 is wider than the visible region 470, the user may be provided with an additional scroll bar to control horizontal position of the display area. Furthermore, the present techniques can be readily adapted to work with multidimensional data systems, such a three-dimensional data cube.

FIG. 5 illustrates another exemplary single page layout 500 for a content page that can be downloaded in a data network. The single page layout 500 can be implemented for fractional download by a fractional page loader, such as fractional page loader 137 in the client device 110 (FIG. 1).

The single page layout 500 includes a hierarchical arrangement of layers and containers. The first layer corresponds to an entire presentation page 510. The second layer includes containers 522, 524 and 526. Each of the second layer containers reserves a corresponding position and area within the previous layer, i.e., the presentation page 510. According to the hierarchy, the containers 522, 524 and 526 include containers of a third layer. In particular, the container 522 includes containers 531, 532, and 533; container 524 includes containers 534, 535 and 536; and container 526 include containers 537 and 538. In turn, some of the third layer containers 531-538 include containers of a fourth layer. For example, containers 532, 533, 535, 536, 537 and 538 include fourth layer containers 542, 543, 545, 546, 547 and 548, respectively.

The single page layout 500 also includes an active portion which is defined by the visible region 570 corresponding to the scroll bar 580 (there are no buffer regions in this embodiment). Each container in the single page layout 500 corresponds to one or more content elements. However, the containers 522 and 526 and smaller containers therein are “empty” because they are outside of the visible region 570. An empty container does not include the actual content it represents (although it may include other containers or link information or other metadata. Only the container 524 and smaller containers therein are “filled” with actual content elements which are to be downloaded from the server. As the user changes the location of the visible region 570, the client device can download the content for those containers which fall within the new visible region 570. Thus the content page may be displayed without the delay corresponding to the download of the content in the entire page. As discussed above with reference to FIG. 2, the hierarchical arrangement of containers also allows an efficient way to identify the active portion even if the total number of content elements is in the order of several hundred thousands or a million or even more.

In the example shown in FIG. 5, the selection of the containers for downloading content is based on the second level containers. Thus, if a second level container overlaps with the visible region 570, the client device downloads the entire content of that second level container, including content for all lower level containers. In alternative implementations, the client device can download only the content for those higher level containers that actually fall within the visible region 570.

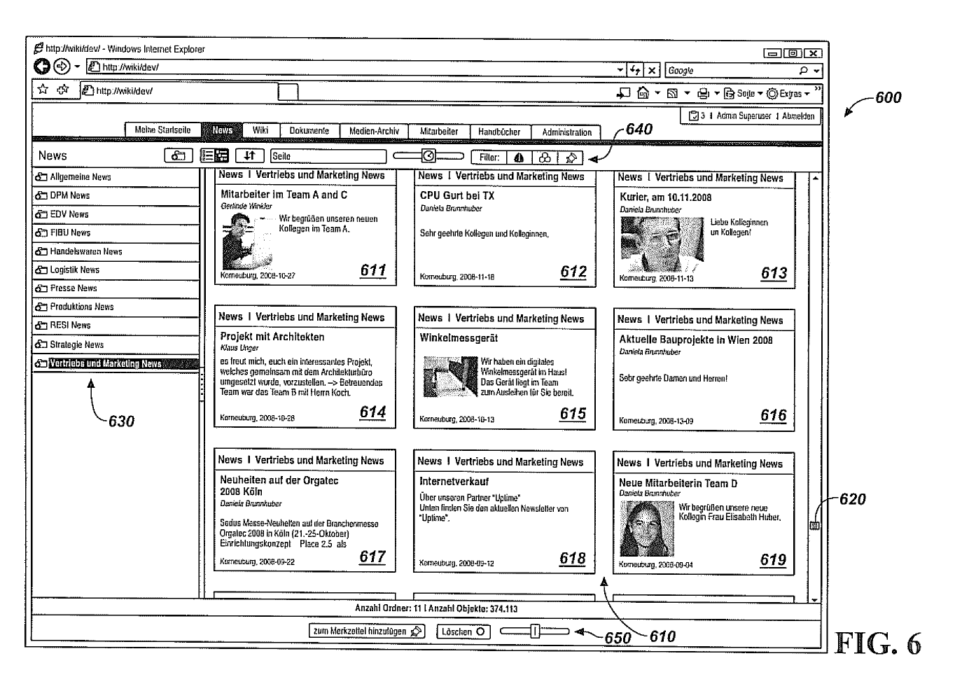

FIG. 6 illustrates an exemplary screen shot 600 from a client device, such as client device 130 (FIG. 1), that includes a browser application with a fractional page loader. In this example, the browser application is an Internet Explorer from Microsoft Corporation, and the fractional page loader is downloaded as a script from a fractional download capable server.

The screen shot 600 illustrates a visible region 610 displaying content elements 611-619 that are previews of news items in this example. Each of the previews 611-619 also includes a link to a more detailed version of the respective news item. In alternative implementations, the content elements 611-619 can correspond to any listing. For example, the content elements can include previews of and corresponding links to documents, images, videos, audio records, any other digital objects or any kind of data set presentations.

In the screen shot 600, the visible region 610 is only a portion of a single page layout, and the user can use a scroll bar 620 or a link map 630 to scroll or jump up or down in the single page layout. As illustrated in this example, the small size of the scroll bar 620 may indicate the large number of available news items in the entire page. The fractional page loader of the client device, however, downloads only those news items which the user actually selects by the scroll bar 620 or links 630. Thus the user may navigate through and preview a large number of different news items without the delay caused by downloading all the news items.

The screen shot 600 also illustrates tools 640 and 650 that the user can use to change the single page layout. In particular the tool 640 includes filters which can eliminate news items based on different conditions. Thus, after reviewing some of the unfiltered data, the user may make in informed choice about what kind of filters he or she wishes to use.

The tool 650 can be used to change the size of the preview items 611-619. For example, the server or the client may provide discrete or continuous scaling of the preview items. Once the scale has been chosen by the user, the client or the server or a combination of the client and the server can identify a new single page layout for the content page.

The techniques of the present application have been described with reference to particular implementations. Other implementations are within the scope of the following claims, and can include many variations. For example, the present techniques can also be adapted to work with multidimensional data systems, such as a three-dimensional data cube. Furthermore, although the present techniques were described in a framework of client-server relations in a data network, they can also be applicable for computer program applications that access and present large amount of information from a database or other data system. The described methods, or portions of them, can be implemented in software hardware, or in a combination of software and hardware. Steps in the described methods can be performed in different order and still provide desirable results.

What is claimed is:

1. A method implemented by a client device for accessing information in a data network, the client device including a local storage unit and a display unit, the method comprising:
identifying a single page layout for a content page to be downloaded from a server in the data network, the single page layout defining a geometrical arrangement of content reservation areas for presenting respective content elements from the entire content page;
identifying an active portion in the single page layout, the active portion corresponding to a display area for displaying the content page on the display unit;
requesting content elements from the server for the content reservation areas in the active portion of the single page layout without requesting content elements for content reservation areas that are outside of the active portion in the single page layout; and
displaying the requested content elements in the display area on the display unit according to the single page layout.

2. The method of claim 1, wherein the single page layout includes a plurality of containers, each container corresponding to a respective area in the single page layout.

3. The method of claim 2, wherein one or more of the containers reserves a respective area for other containers.

4. The method of claim 2, wherein one or more of the containers corresponds to a respective content reservation area.

5. The method of claim 2, wherein the plurality of containers are hierarchically arranged in two or more layers including first and second layers, wherein the first layer has at least one container that includes one or more containers of the second layer.

6. The method of claim 5, further comprising:
changing the number of layers or the number of containers in another container in response to a performance parameter.

7. The method of claim 5, wherein at least one container of the first layer includes between one and 150 containers of the second layer.

8. The method of claim 5, wherein identifying the active portion includes identifying the active portion based on the hierarchical arrangement of the containers.

9. The method of claim 8, wherein identifying the active portion based on the hierarchical arrangement includes identifying a first level container that includes the active portion and subsequently identifying within the first level container a second level container that includes the active portion.

10. The method of claim 2, wherein the single page layout includes more than ten thousand containers.

11. The method of claim 1, wherein identifying the single page layout includes:
sending information to the server about the display area for displaying the content page; and
receiving the single page layout for the content page from the server.

12. The method of claim 1, wherein the content elements include previews, each preview including a visual presentation and a link to a content object corresponding to that preview.

13. The method of claim 12, wherein the linked content object includes an image.

14. The method of claim 12, wherein the linked content object includes a document, video data, audio data, or a data set from a database.

15. The method of claim 1, further comprising:
receiving user input requesting change in the active portion;
identifying a new active portion in the single page layout according to the user input;
requesting content elements from the server for the new active portion without requesting content elements that are outside of the new active portion in the single page layout; and
displaying the requested content elements in the display area on the display unit according to the single page layout.

16. The method of claim 15, wherein receiving user input includes receiving user input requesting scrolling up or down in the content page.

17. The method of claim 15, wherein receiving user input includes receiving user input requesting display of a specific portion in the content page.

18. The method of claim 17, wherein receiving user input requesting display of a specific portion in the content page includes receiving user input requesting a jump to the specific portion by using links from a user interface map showing a structure of the content page.

19. The method of claim 1, further comprising:
receiving user input requesting change in the single page layout;
identifying a new single page layout for the content page according to the user input;
identifying a new active portion in the new single page layout;
requesting content elements from the server for the new active portion without requesting content elements that are outside of the new active portion in the new single page layout; and
displaying the requested content elements in the display area on the display unit according to the new single page layout.

20. The method of claim 19, wherein receiving user input includes receiving user input requesting a change in the display area.

21. The method of claim 19, wherein receiving user input includes receiving user input requesting filtering the content elements in the content page.

22. The method of claim 19, wherein receiving user input includes receiving user input requesting a larger or smaller representation of the content elements in the content page.

23. A software product, tangibly embodied in a computer readable medium, for accessing information by a client device in a data network, the client device including a local storage unit and a display unit the software product including instructions to cause data processing apparatus in the client device to perform operations comprising:
identifying a single page layout for a content page to be downloaded from a server in the data network, the single page layout defining a geometrical arrangement of content reservation areas for presenting respective content elements from the entire content page;
identifying an active portion in the single page layout, the active portion corresponding to a display area for displaying the content page on the display unit;
requesting content elements from the server for the content reservation areas in the active portion of the single page layout without requesting content elements for content reservation areas that are outside of the active portion in the single page layout; and
displaying the requested content elements in the display area on the display unit according to the single page layout.

24. The method of claim 23, wherein the single page layout includes a plurality of containers, each container corresponding to a respective area in the single page layout, and wherein the plurality of containers are hierarchically arranged in two or more layers including first and second layers, wherein the first layer has at least one container that includes one or more containers of the second layer.

25. The method of claim 24, wherein identifying the active portion based on the hierarchical arrangement includes identifying a first level container that includes the active portion and subsequently identifying within the first level container a second level container that includes the active portion.

26. A method implemented by a server for providing information in a data network, the server including a controller and a storage unit, the method comprising:
receiving information about display parameters of a client device in the data network;
determining a single page layout based on the display parameters for a content page to be downloaded to the client device, the single page layout defining a geometrical arrangement of content reservation areas for presenting respective content elements from the entire content page;
sending information about the single page layout to the client device;
receiving a request from the client device for content elements in an active portion of the single page layout; and
sending to the client device the content elements for the content reservation areas in the active portion of the single page layout without sending content elements for content reservation areas that are outside of the active portion in the single page layout.

27. The method of claim 26, wherein the single page layout includes a plurality of containers, each container corresponding to a respective area in the single page layout, and wherein the plurality of containers are hierarchically arranged in two or more layers including first and second layers, wherein the first layer has at least one container that includes one or more containers of the second layer.

28. The method of claim 26, further comprising:
receiving a request from the client device for information in the content page; and
sending page initialization information to the client device in response to the request.

29. The method of claim 27, wherein the page initialization information includes information for a fractional page loader in the client device, wherein the fractional page loader is configured to identify an active portion in the single page layout and to request the content elements for the active portion from the server.

30. The method of claim 28, wherein the fractional page loader is in a JavaScript format.

31. The method of claim 26, wherein the data network includes the World Wide Web and the server provides information from a website.

32. A client system for accessing information in a data network, the system comprising:
a storage unit;
a display unit; and
data processing apparatus configured to perform operations comprising:
identifying a single page layout for a content page to be downloaded from a server in the data network, the single page layout defining a geometrical arrangement of content reservation areas for presenting respective content elements from the entire content page;
identifying an active portion in the single page layout, the active portion corresponding to a display area for displaying the content page on the display unit;
requesting content elements from the server for the content reservation areas in the active portion of the single page layout without requesting content elements for content reservation areas that are outside of the active portion in the single page layout; and
displaying the requested content elements in the display area on the display unit according to the single page layout.

33. The system of claim 32, wherein the single page layout includes a plurality of containers, each container corresponding to a respective area in the single page layout, and wherein the plurality of containers are hierarchically arranged in two or more layers including first and second layers, wherein the first layer has at least one container that includes one or more containers of the second layer.

34. The system of claim 33, wherein identifying the active portion based on the hierarchical arrangement includes identifying a first level container that includes the active portion and subsequently identifying within the first level container a second level container that includes the active portion.

35. A server system for providing information in a data network, the system comprising:
a storage unit; and
a controller configured to perform operations comprising:
receiving information about display parameters of a client device in the data network;
determining a single page layout based on the display parameters for a content page to be downloaded to the client device, the single page layout defining a geometrical arrangement of content reservation areas for presenting respective content elements from the entire content page;
sending information about the single page layout to the client device; receiving a request from the client device for content elements in an active portion of the single page layout; and
sending to the client device the content elements for the content reservation areas in the active portion of the single page layout without sending content elements for content reservation areas that are outside of the active portion in the single page layout.

36. The system of claim 35, wherein the single page layout includes a plurality of containers, each container corresponding to a respective area in the single page layout, and wherein the plurality of containers are hierarchically arranged in two or more layers including first and second layers, wherein the first layer has at least one container that includes one or more containers of the second layer.

37. The system of claim 35, further comprising:
receiving a request from the client device for information in the content page; and
sending page initialization information to the client device in response to the request, wherein the page initialization information includes information for a fractional page loader in the client device, the fractional page loader configured to identify an active portion in the single page layout and to request the content elements for the active portion from the server system.

38. The method of claim 35 wherein the data network includes the World Wide Web and the server system provides information from a website.
